(19) United States
(12) Patent Application Publication
(10) Pub. No.: US 2022/0023914 A1
(43) Pub. Date: Jan. 27, 2022

(54) DEVICE FOR CURING COATING SUBSTANCE

(71) Applicants: Mika LOKKINEN, Tallinn (EE); PICOTE SOLUTIONS INC., Sammamish, WA (US)

(72) Inventor: Mika Lokkinen, Tallinn (EE)

(73) Assignee: Picote Solutions Inc., Sammamish, WA (US)

(21) Appl. No.: 17/426,360

(22) PCT Filed: Feb. 3, 2020
(86) PCT No.: PCT/EP2020/052575

§ 371 Date: Jul. 28, 2021

(30) Foreign Application Priority Data
Feb. 4, 2019 (EP) 19155387.4

(51) Int. Cl. B05D 3/06; F16L 55/18; B05D 7/22

(52) U.S. Cl. CPC B05D 3/067; B05D 2254/04; B05D 7/225; F16L 55/18

(57) ABSTRACT

The device is for curing a coating substance inside a pipe. The device has a flexible shaft inside a duct, an air inlet channel within the duct, a body configured to be attached to the duct, a heat sink in connection with the body and defining a plurality of cooling channels which are in fluid connection with the air inlet channel. The device further has a plurality of light emitting devices configured to be cooled by the heat sink. The device further has an air outlet channel in fluid connection with the cooling channels of the heat sink. The air outlet channel exits the body from the same side of the body as the air inlet channel enters the body.

### FIELD OF THE INVENTION

The present invention relates to devices for curing internal coating of a pipe, and especially illumination devices for curing internal coating of a pipe.

### BACKGROUND OF THE INVENTION

Pipe systems have for long been renovated by pumping coating substance to the pipe system being renovated and by levelling the coating substance to form a layer no more than 1 mm thick and with relative evenness on the inner surface of the pipe by means of rotating a brush. After the coating has cured, the treating has been repeated from two to four times to achieve an adequate coating thickness and to cover the possible impurities left in the pipe system entirely within the coating.

A problem with the arrangement described in the above is the slow progress of the work, because a plurality of coating layers are needed and a previous layer needs to cure before the subsequent is spread. The number of coating layers needed depends on viscosity of the coating substance. Lower viscosity coating substance requires more layers than high viscosity coating substance.

### BRIEF DESCRIPTION OF THE INVENTION

An object of the present invention is to provide a device which decreases curing time of a coating substance and thereby alleviates or eliminates the problems of the prior art.

An aspect of the present invention is a device having a plurality of light emitting devices which are cooled with heat sinks and air flow. An air inlet channel is inside a duct and after flowing through the heat sink, air exits the device through an air outlet channel in which the air flows in a direction substantially parallel but opposite to air inlet channel.

The object of the invention is achieved with a device presented in independent claim. Advantageous embodiments are presented in dependent claims.

### BRIEF DESCRIPTION OF THE DRAWINGS

In the following the present invention is described in greater detail by means of preferred embodiments with reference to the accompanying drawings, in which

FIG. 1 is a cross-section in length direction of a device according to an embodiment,

FIG. 2 is a cross-section in width direction of a device according to an embodiment,

FIG. 3 illustrates a device without a dome according to an embodiment,

FIG. 4 illustrates a device according to an embodiment,

FIG. 5 illustrates a device without a dome according to an embodiment, and

FIG. 6 illustrates insides of a device according to an embodiment.

### DETAILED DESCRIPTION OF THE INVENTION

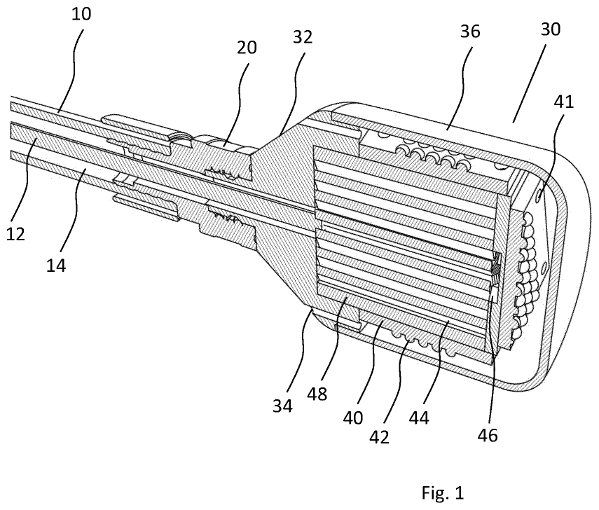

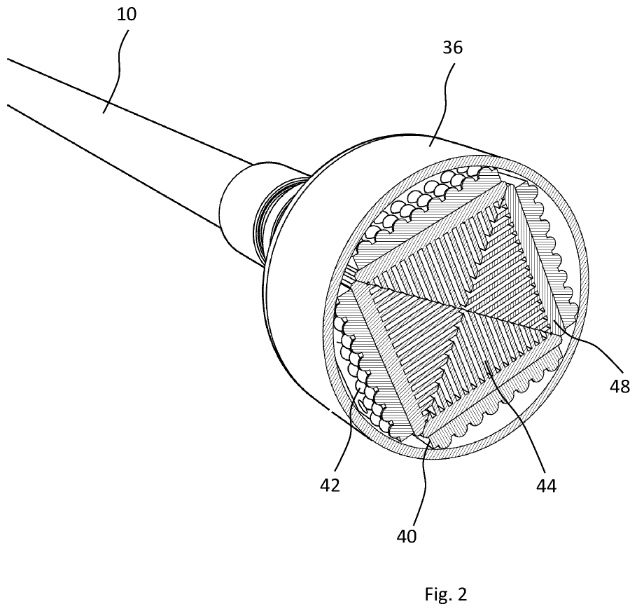

FIG. 1 shows a length-wise cross-section and FIG. 2 shows a width-wise cross-section of a device 30 according to an embodiment of the invention. The device 30 is designed for curing a coating substance inside a pipe, i.e. on the inner wall of the pipe. The device comprises a flexible shaft 12 disposed at least partially inside a duct 10. The internal diameter of the duct 10 is larger than the external diameter of the flexible shaft 12 so that an air inlet channel 14 is formed between the flexible shaft 12 and the duct 10. The flexible shaft 12 is preferably a flexible wound steel cable. The combination of the flexible shaft and the duct is flexible but preferably stiff enough to push, pull and turn the device.

The device has a body 32 configured to be attached to the duct 10, either directly or with a connector 20. For example connectors used with compressors and hoses for compressed air can be used. The flexible shaft 12 preferably extends further than the duct and the flexible shaft can preferably be attached to the body 32, for example with screws or friction screws.

The device has one or more heat sinks 48 in connection with the body 32, attached to the body or as a part of the body. The one or more heat sinks define a plurality of cooling channels 44 which are in fluid connection with the air inlet channel 14. Fluid connection means that air and other fluids can flow between two points that are in fluid connection with each other. In this case, there can an aperture in the body 32 which connects the inside of the duct 10 to the cooling channels 44 of the heat sink 48 as shown in FIG. 1. In an embodiment, the air inlet channel enters only a portion of the cooling channels of the one or more heat sinks. On an end of the one or more heat sinks, opposite to the air inlet channel can be a dividing channel 46 which connects all the cooling channels 44 of the one or more heat sinks. This structure forces the air to pass the one or more heat sinks at least twice thereby improving the cooling effect of the flowing air. In an embodiment the cooling channels 44 of the heat sink 48 extend in a length direction shown as ‘L’ in FIG. 4 and the same direction applies to all embodiments. In that embodiment, the dividing channel 46 which connects all the cooling channels 44 of the one or more heat sinks extends in width direction, perpendicular to the length direction L. The dividing channel 46 can be seen in FIG. 1 and FIG. 6.

The device further comprises a plurality of light emitting devices 42 which are configured to be cooled by the one or more heat sinks 48, i.e. heat formed in the light emitting devices 42 is conducted to the one or more heat sinks. Electric power to the light emitting devices 42 is supplied with wires, for example with wires running inside the duct 10, outside the duct 10 or within the duct 10. The light emitting devices 42 can be in a form of arrays where multiple light emitting devices 42 are attached to a base plate 40 which is then attached to one or more heat sinks 48.

In an embodiment, the light emitting devices 42 are ultra-violet light emitting devices. Ultra-violet light is the most common electromagnetic radiation used for curing coating substances at the moment. As new coating substances are being developed, some other colours or wavelengths could also be used. In an embodiment, the light emitting devices 42 are ultra-violet light emitting diodes, i.e. UV LEDs. The LED itself can emit UV light or the LED can emit some other wavelength which is converted to UV light by means of coating or quantum dot technology.

In an embodiment, the device 30 comprises light emitting devices 42 facing at least four different directions which are perpendicular to the length direction L of the device. Preferably, the device 30 also comprises light emitting devices 42 facing to a direction parallel to the length direction L of the device, and most preferably facing to a direction away from the duct 10.

The device also comprises an air outlet channel 34 in fluid connection with the cooling channels 44 of the one or more heat sinks 48. The air outlet channel 34 preferably exits the body 32 from the same side of the body 32 as the air inlet channel 14 enters the body 32. This means that the air flows in the air inlet channel 14 and in the air outlet channel 34 are parallel but the directions of flows are opposite. It is important that the air flow does not exit from an end opposite to the end where it enters the body 32. Because the light emitted by the light emitting devices 42 expedites curing of a coating substance, the output air flow must be directed so that it doesn't disturb any uncured coating surfaces. A strong air flow would cause wave patterns and other unwanted transformations to the uncured coating surfaces. The device 30 is intended to be pushed forward in a recently coated pipe using the flexible shaft 12 and the duct 10. Therefore, it is safe to direct the output air flow in the direction of the duct 10 as that side of the body 32 has already been cured.

UV light devices for curing epoxy resin in CIPP liners usually have power from several hundreds of watts to a few thousand watts. These power levels produce a vast amount of heat which is a problem in a small, confined space like inside a pipe. Cooling requires massive heat sinks and rapid air flow to keep temperature low enough. These devices designed for curing CIPP liners are not suitable for curing coating applied directly to the inner surface of a pipe, due to the excess heat formation and the rapid air flow. That is also a safety issue since any problem with cooling of these devices would cause a severe risk of igniting the coating on fire. The device (30) of the present disclosure is adapted for curing coating substance that has been applied directly to the inner surface of a pipe. The device can operate with less than 20 watts of total LED power consumption, preferably less than 10 watts of total LED power consumption. The applicant has found that even 8 watts of total LED power consumption is enough to cure the coating substance and an increase of power from that level does not have a significant impact on the curing time. The lower power consumption also means less heat to be dissipated from the heat sinks, thus the air flow can be relatively weak compared to the devices for curing CIPP liners.

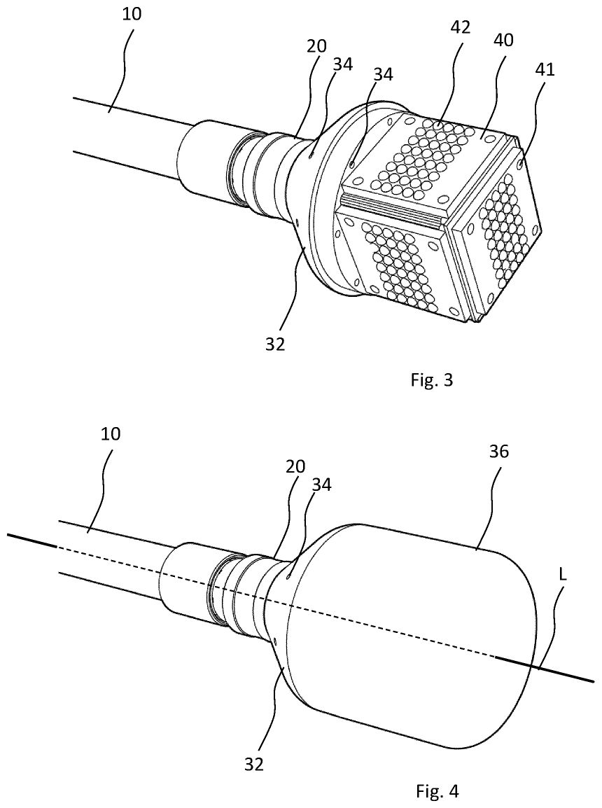

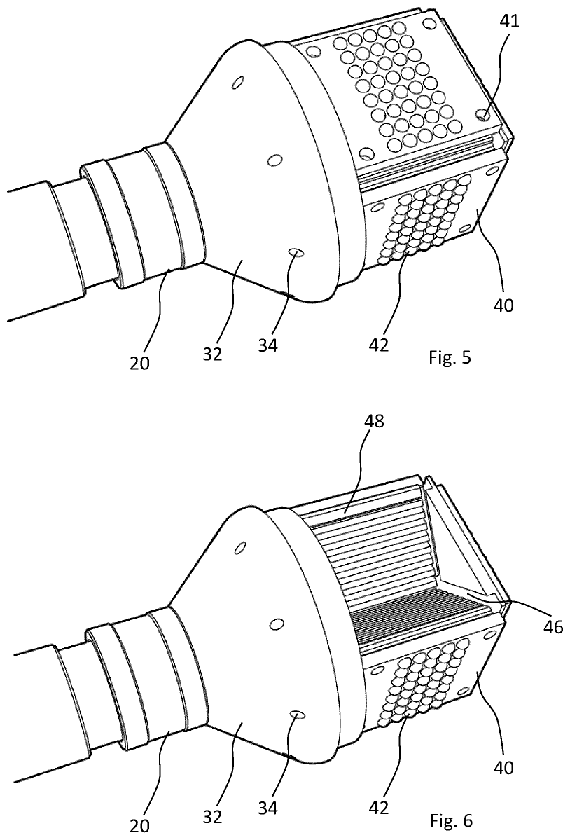

FIG. 3 and FIG. 5 illustrates a device 30 according to an embodiment from two different angles. FIG. 4 illustrates the same device with a dome 36 housing the light emitting devices 42 inside the dome. The dome 36 is transparent, at least to some wavelengths of the light emitted by the light emitting devices 42. The dome 36 preferably defines an air space between the inner wall of the dome 36 and the light emitting devices 42. The air space is in fluid connection with the cooling channels 44 of the heat sink 48 and the air outlet channel 34. Thereby the light emitting devices are cooled from the back side with the one or more heat sinks 48 and from the front side with air flow. The fluid connection can be arranged for example by apertures 41 in the base plates 40.

In an embodiment the air outlet channel 34 is a through-hole in the body 32 and parallel to the air inlet channel 14 or the length direction L of the device. Depending on the structure of the device, the air outlet channel 34 can also be a through-hole in some other part of the device 30. Air is configured to flow in the air inlet channel 14 to an opposite direction to air flowing in the air outlet channel 34, or at least said flows have a component opposite to each other.

It will be obvious to a person skilled in the art that, as the technology advances, that the inventive concept can be implemented in various ways. The present invention and its embodiments are not limited to the examples described above but may vary within the scope of the claims.

I claim:

1. A device for curing a coating substance inside a pipe, the device comprising:
a flexible shaft disposed at least partially inside a duct,
an air inlet channel between the flexible shaft and the duct,
a body configured to be attached to the duct,
a heat sink in connection with the body and defining a plurality of cooling channels which are in fluid connection with the air inlet channel, and
a plurality of light emitting devices configured to be cooled by the heat sink,
wherein the device further comprises an air outlet channel in fluid connection with the cooling channels of the heat sink, and the air outlet channel exits the body from the same side of the body as the air inlet channel enters the body.

2. The device according to claim 1, wherein the cooling channels of the heat sink extend in a length direction (L).

3. The device according to claim 1, wherein the device further comprises a transparent dome housing the light emitting devices inside the dome.

4. The device according to claim 3, wherein the dome defines an air space between the inner wall of the dome and the light emitting devices and that the air space is in fluid connection with the cooling channels of the heat sink and the air outlet channel.

5. The device according to claim 1, wherein the air outlet channel is a through-hole in the body, parallel to the air inlet channel or the length direction (L) of the device.

6. The device according to claim 1, wherein the light emitting devices are ultra-violet light emitting devices.

7. The device according to claim 1, wherein the light emitting devices are UV LEDs.

8. The device according to claim 1, wherein the device comprises light emitting devices facing at least four different directions which are perpendicular to the length direction (L) of the device.

9. The device according to claim 1, wherein the device comprises light emitting devices facing to a direction parallel to the length direction (L) of the device.
